(19) United States
(12) Patent Application Publication
(10) Pub. No.: US 2008/0054804 A1
(43) Pub. Date: Mar. 6, 2008

(54) Optical coupling element and electronic device

(75) Inventors: Takeshi Kitamura, Nara (JP); Tomoya Furutsu, Nara (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka-shi (JP)

(21) Appl. No.: 11/790,788

(22) Filed: Apr. 27, 2007

(30) Foreign Application Priority Data
Sep. 6, 2006 (JP) 2006-161288

(51) Int. Cl. G02B 6/26

(52) U.S. Cl. 313/512

(57) ABSTRACT

In an embodiment of the present invention, in an optical coupling element comprising a light emitting element and a light receiving element, a transparent sealing portion for sealing these elements, an opaque sealing portion that covers the transparent sealing portion, and terminals that are connected individually to the electrodes of the light emitting element and the light receiving element and are drawn out from a side face of the opaque sealing portion, the creeping distance being the sum of the gap distance between these terminals and their opposite side faces and the distance between the bottom edges of the side faces, a creeping distance extension face for extending the creeping distance is provided between the bottom face and the side face of the opaque sealing portion, and the gap distance between the terminals and the edge formed by the bottom face and this creeping distance extension face is set to a specific distance.

This application claims priority under 35 U.S.C. § 119(a) to Japanese Patent Application 2006-161288 filed in Japan on Jun. 9, 2006, the entire contents of which are hereby incorporated herein.

### BACKGROUND OF THE INVENTION

1. Field of the Invention

The present invention relates to an optical coupling element with a lengthened creeping distance, and to an electronic device in which this optical coupling element is used.

2. Description of the Related Art

As electronic devices have become smaller in recent years, there has been a need to make electronic components smaller or thinner, and because of this, small or thin optical coupling elements have been put on the market.

FIG. 8A is a side view of a conventional optical coupling element, and FIG. 8B is a plan view of the same. These drawings do not show a taper formed in a package (also called an opaque sealing portion) 922 and extending from a center face 922c of an optical coupling element 901 to a top face 922t or bottom face 922b of the package.

The optical coupling element 901 is made up of a light emitting element and a light receiving element, a transparent sealing portion (not shown) that seals these elements with a transparent resin, an opaque sealing portion 922 that covers the transparent sealing portion, a pair of terminals 931 (primary terminals 931f) connected to the light emitting element, and a pair of terminals 931 (secondary terminals 931s) connected to the light receiving element. A step 922m is formed in the top face 922t of the opaque sealing portion 922 by making a cut-plane so that the primary terminals 931f can be distinguished from the secondary terminals 931s.

The terminals 931 are drawn out from side faces 922hs of the opaque sealing portion 922, and are bent in the direction of the bottom face 922b at a distance of about 0.86 mm from the side face 922hs. That is, the distance d between the primary terminals 931f (or secondary terminals 931s) and the side face 922hs is set to less than 1 mm, which narrows the gap between the primary terminals 931f and the secondary terminals 931s, thereby reducing the size of the optical coupling element 901 and reducing the mounting surface area on a substrate.

Incidentally, in the interest of safety, electronic components such as the optical coupling element 901 are subject to safety regulations regarding their creeping distance CD. The creeping distance CD is defined as the shortest distance between two conductive portions having an insulator sandwiched in between, as measured along the surface of the insulator. In other words, with the optical coupling element 901, the shortest distance between the primary terminals 931f and the secondary terminals 931s, as measured along the surface of the opaque sealing portion 922, is termed the creeping distance CD.

Particularly with a small optical coupling element 901, a special method has been established for measuring the creeping distance because the distance d between the primary terminals 931f (or secondary terminals 931s) and the side face 922hs is extremely short. More specifically, with an optical coupling element 901 in which the distance d between the primary terminals 931f (or secondary terminals 931s) and the side face 922hs is less than 1 mm, the directly measured distance between the primary terminals 931f and the secondary terminals 931s is termed the creeping distance CD. That is, with an optical coupling element 901 such as this, the creeping distance CD is the same as the spatial distance (the distance between the terminals). With the optical coupling element 901 shown in FIG. 8, the creeping distance CD is expressed by the following Formula (1).

Creeping distance CD=P1P2+P2P3+P3P4 (1)

Therefore, with a small optical coupling element 901, it is necessary to ensure the creeping distance CD stipulated in safety regulations, or it is necessary to ensure a creeping distance CD for guaranteeing a satisfactory level of safety, but it is difficult to ensure an adequate creeping distance CD because of the extremely short distance d between the primary terminals 931f (or secondary terminals 931s) and the side face 922hs.

In view of this, an optical coupling element has been proposed in JP H10-84128A (hereinafter referred to as Patent Document 1) in which the creeping distance CD is lengthened by expanding the lower part of the opaque sealing portion, or by forming at least the bottom face of the opaque sealing portion to have a corrugated shape.

Nevertheless, although the technique disclosed in Patent Document 1 does allow the creeping distance to be lengthened, it has the following problems. When the lower part of the opaque sealing portion is expanded, the size reduction of the element cannot be achieved. When the bottom face of the opaque sealing portion is formed to have a corrugated shape without expanding the lower part of the opaque sealing portion so as to achieve the size reduction, the volume of the transparent sealing portion is reduced, which affects the layout of the light emitting element and the light receiving element.

### SUMMARY OF THE INVENTION

The present invention was conceived in light of this situation, and it is an object of the present invention to provide an optical coupling element that is compact and has a lengthened creeping distance, and an electronic device in which this optical coupling element is used.

The optical coupling element according to the present invention is an optical coupling element, comprising a light emitting element and a light receiving element, a transparent sealing portion for sealing these elements, an opaque sealing portion that covers the transparent sealing portion, and terminals that are connected individually to the electrodes of the light emitting element and the light receiving element and are drawn out from a side face of the opaque sealing portion, the creeping distance being the sum of the gap distance between these terminals and their opposite side faces and the distance between the bottom edges of the side faces, wherein a creeping distance extension face for extending the creeping distance is provided between the bottom face and the side face of the opaque sealing portion, and the gap distance between the terminals and the edge formed by the bottom face and this creeping distance extension face is set to a specific distance.

With this constitution, the creeping distance can be lengthened because the creeping distance extension face is provided to the opaque sealing portion. Therefore, insulation between the terminals can be improved.

Also, with the optical coupling element according to the present invention, the specific distance may be greater than 1 mm.

With this constitution, since the terminals are separated from the side face by a distance greater than 1 mm, the creeping distance can be lengthened more reliably.

Also, with the optical coupling element according to the present invention, the creeping distance extension face may be planar.

With this constitution, because the creeping distance extension face has a simple shape, it is easier to form the opaque sealing portion.

Also, with the optical coupling element according to the present invention, the creeping distance extension face may comprise a plurality of faces or may be curved.

With this constitution, the latitude in the design of the opaque sealing portion can be broadened. For instance, the opaque sealing portion can be given the appropriate thickness by disposing a plurality of planar surfaces so that they bulge outward.

Also, with the optical coupling element according to the present invention, the creeping distance extension face may be provided individually at the drawn-out location of each of the terminals.

With this constitution, there is no decrease in heat resistance because the creeping distance is lengthened without diminishing the amount of resin in the opaque sealing portion. Also, since a reduction in the surface area of the bottom face can be made small, mounting on the mounting substrate is more stable.

Also, with the optical coupling element according to the present invention, the transparent sealing portion may be formed such that portions corresponding to the creeping distance extension face form faces that conform to the creeping distance extension face.

With this constitution, enough thickness to ensure good heat resistance can be ensured at places corresponding to the creeping distance extension faces.

Also, with the optical coupling element according to the present invention, light emitting element mounting portions and/or light receiving element mounting portions of the terminals are inclined toward the bottom face.

With this constitution, optical transmission efficiency is improved because the optical axes of the light emitting element and the light receiving element intersect.

Also, the electronic device according to the present invention is an electronic device comprising a load control circuit for controlling a load circuit, wherein the load control circuit comprises an optical coupling element described above.

With this constitution, the electrical safety of an electronic device can be enhanced without increasing the mounting surface area.

### BRIEF DESCRIPTION OF THE DRAWINGS

FIG. 1A is a side view of the optical coupling element according to Embodiment 1 of the present invention;

FIG. 1B is a side view in the direction of arrow AA in FIG. 1A;

FIG. 1C is a bottom view of the optical coupling element according to Embodiment 1 of the present invention;

FIG. 2 is a cross section along the I-I line in FIG. 1B, illustrating the optical coupling element according to Embodiment 1 of the present invention;

FIG. 3 is a diagram illustrating the creeping distance of the optical coupling element according to Embodiment 1 of the present invention;

FIG. 4A is a side view of the optical coupling element according to Embodiment 2 of the present invention;

FIG. 4B is a side view in the direction of arrow BB in FIG. 4A;

FIG. 4C is a bottom view of the optical coupling element according to Embodiment 2 of the present invention;

FIG. 5 is a side view of the optical coupling element according to Embodiment 3 of the present invention;

FIG. 6 is a side view of the optical coupling element according to Embodiment 4 of the present invention;

FIG. 7 is a cross section of the optical coupling element according to Embodiment 5 of the present invention;

FIG. 8A is a side view of a conventional optical coupling element; and

FIG. 8B is a plan view of a conventional optical coupling element.

### DESCRIPTION OF THE PREFERRED EMBODIMENTS

Embodiments of the present invention will now be described through reference to the drawings.

### Embodiment 1

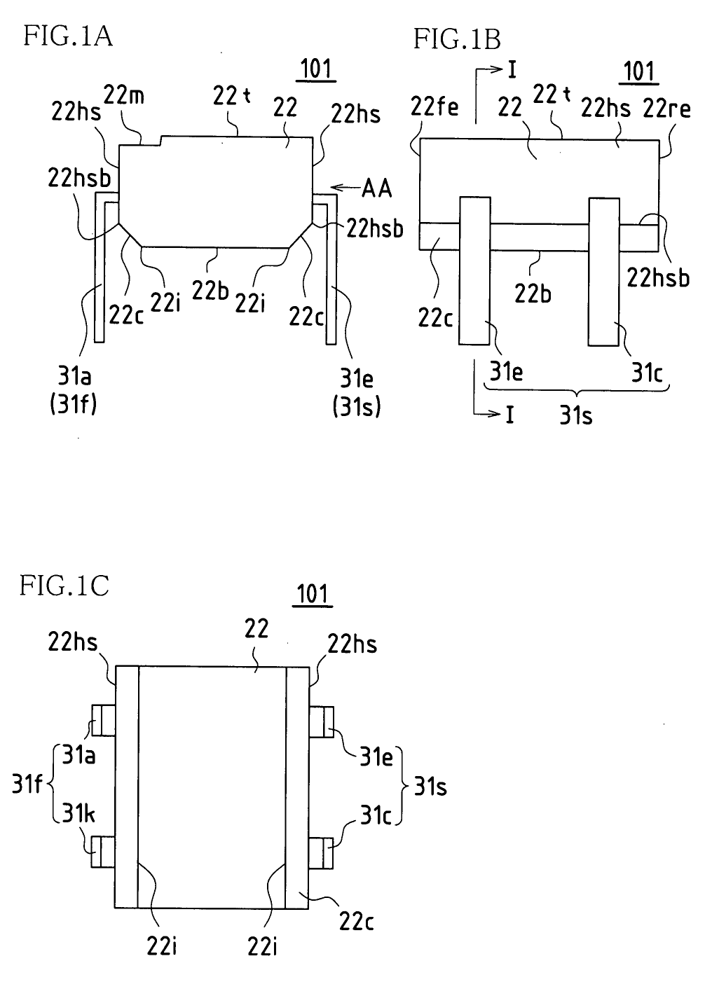

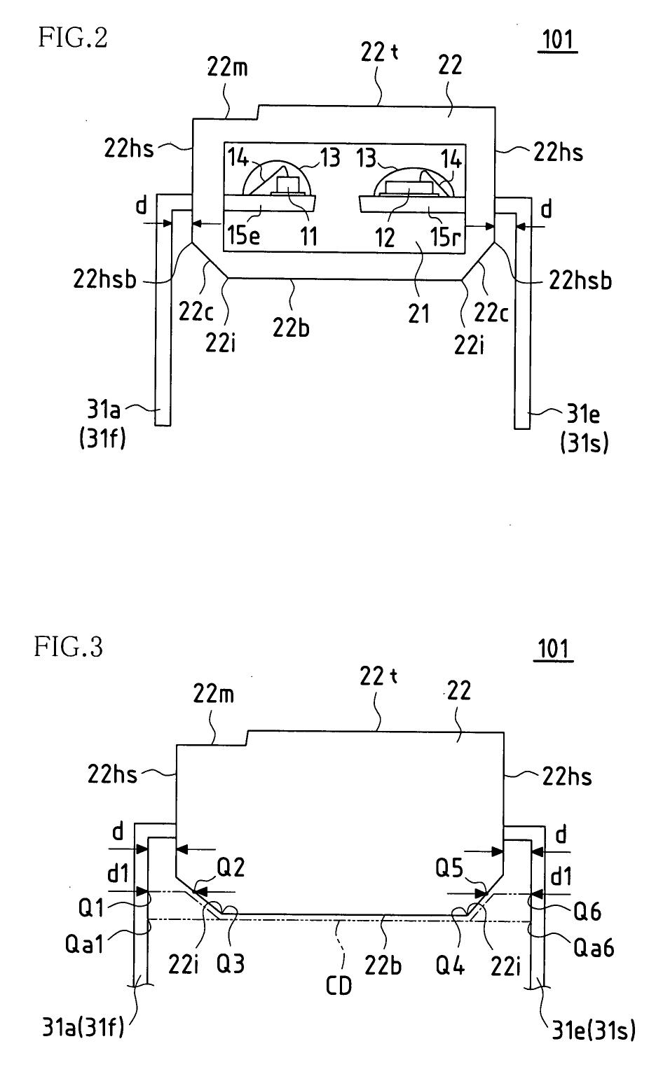

FIG. 1A is a side view of the optical coupling element according to Embodiment 1 of the present invention, FIG. 1B is a side view in the direction of arrow AA in FIG. 1A, and FIG. 1C is a bottom view of the optical coupling element according to Embodiment 1 of the present invention. FIG. 2 is a cross section along the I-I line in FIG. 1B, illustrating the optical coupling element according to Embodiment 1 of the present invention.

As shown in FIG. 2, the optical coupling element 101 according to an embodiment of the present invention is made up of a transparent sealing portion 21 that seals a light emitting element 11 and a light receiving element 12 that have been coated with a transparent resin 13, an opaque sealing portion 22 that covers the transparent sealing portion 21, a pair of terminals 31f (primary terminals 31a and 31k) connected to the light emitting element 11, and a pair of terminals 31s (secondary terminals 31e and 31c) connected to the light receiving element 12. A step 22m is formed in the top face 22t of the opaque sealing portion 22 so that the primary terminals 31f can be distinguished from the secondary terminals 31s.

The light emitting element 11 and the light receiving element 12 are mounted, respectively, on a light emitting element mounting portion 15e of the terminals 31f and a light receiving element mounting portion 15r of the terminals 31s. Also, the light emitting element 11 and the light receiving element 12 are covered by the transparent resin 13, which has elasticity. The transparent resin 13 serves to cushion the stress applied to the light emitting element 11 and the light receiving element 12. Also, the transparent resin 13 coating the light emitting element 11 serves to focus the light emitted by the light emitting element 11, and the transparent resin 13 coating the light receiving element 12 serves to converge the light on the light receiving element 12. Silicone or the like can be used as the transparent resin 13, for example.

The transparent sealing portion 21 integrally covers and seals the light emitting element 11 and the light receiving element 12. The transparent sealing portion 21 is formed from a transparent epoxy resin or the like, for example. With this constitution, the light from the light emitting element 11 is transmitted without loss to the light receiving element 12.

The opaque sealing portion 22 covers the transparent sealing portion 21, protects the entire optical coupling element 101 from heat, and is formed from a resin that is resistant to heat. For example, the opaque sealing portion 22 may be formed from an epoxy resin containing a glass filler. Also, creeping distance extension faces 22c are formed between the side faces 22hs and the bottom face 22b of the opaque sealing portion 22.

The primary terminals 31f and the secondary terminals 31s are disposed opposite one another with the opaque sealing portion 22 in between. The primary terminals 31f are constituted by a cathode terminal 31k and an anode terminal 31a, while the secondary terminals 31s are constituted by a collector terminal 31c and an emitter terminal 31e.

The light emitting element 11 is mounted on the light emitting element mounting portion 15e, which is formed at one end of the cathode terminal 31k. The other end of the cathode terminal 31k is drawn out to the outside from the side face 22hs of the opaque sealing portion 22. A connection portion (not shown) formed at one end of the anode terminal 31a is connected by a gold (Au) wire 14 or the like to a surface electrode of the light emitting element 11. The other end of the anode terminal 31a is drawn out to the outside from the side face 22hs of the opaque sealing portion 22. The cathode terminal 31k and the anode terminal 31a are both bent at approximately 90 degrees in the direction of the bottom face 22b at a point less than 1 mm (d<1 mm in FIG. 2) from the side face 22hs.

The light receiving element 12 is mounted on the light receiving element mounting portion 15r formed at one end of the collector terminal 31c. The other end of the collector terminal 31c is drawn out to the outside from the side face 22hs of the opaque sealing portion 22. A connection portion (not shown) formed at one end of the emitter terminal 31e is connected by a gold (Au) wire 14 or the like to an emitter electrode formed on the light receiving element 12. The other end of the emitter terminal 31e is drawn out to the outside from the side face 22hs of the opaque sealing portion 22. The collector terminal 31c and the emitter terminal 31e are both bent at approximately 90 degrees in the direction of the bottom face 22b at a point less than 1 mm (d<1 mm in FIG. 2) from the side face 22hs.

The creeping distance extension faces 22c provided to the opaque sealing portion 22 will now be described.

The creeping distance extension faces 22c are faces formed so as to separate the bottom face 22b from the terminal 31a (31e, 31k, 31c) and lengthen the creeping distance of a small optical coupling element (this creeping distance will be discussed below).

More specifically, the creeping distance extension faces 22c are formed as cut-off faces with an angle of approximately 45 degrees, each formed from a side face 22hs to the bottom face 22b. The edges 22i formed by the bottom face 22b and the creeping distance extension faces 22c are each constituted so as to be at least a specific distance from the terminals. Also, the creeping distance extension faces 22c are provided all the way from a front end 22fe of the opaque sealing portion 22 to a rear end 22re of the same. The cut-off angle is not limited to being 45 degrees, and may be any angle that allows the corners formed by the side faces 22hs and the bottom face 22b in a conventional optical coupling element to be cut off.

Providing the creeping distance extension faces 22c separates the primary terminals or secondary terminals (hereinafter also referred to simply as terminals) from the side edges of the bottom face 22b, and lengthens the creeping distance CD between the primary terminals 31f and the secondary terminals 31s, and therefore increases insulation between the terminals (between the primary terminals 31f and the secondary terminals 31s).

The edges 22i (side edges of the bottom face 22b) formed by the creeping distance extension faces 22c and the bottom face 22b are preferably separated by more than 1 mm from the primary terminals 31f (or the secondary terminals 31s). This lengthens the creeping distance CD as measured by a special measurement method (discussed above in Prior Art and below) applied to an optical coupling element 101 in which the distance between the terminals 31 and the side faces 22hs is less than 1 mm.

Next, the creeping distance CD of the optical coupling element 101 according to this embodiment will be described.

FIG. 3 is a diagram illustrating the creeping distance of the optical coupling element according to Embodiment 1 of the present invention.

With an optical coupling element 101 in which the distance between the terminals 31f,31s and the side faces 22hs is less than 1 mm, the creeping distance CD is calculated as the sum of the gap distance between the terminals and their opposite side faces 22hs, and the distance between the bottom edges 22hsb of the side faces 22hs.

More specifically, the creeping distance CD is calculated by measuring the distance between a portion Q1 of the primary terminals 31f where the distance to the creeping distance extension face 22c is 1 mm (the portion where d1=1 mm in FIG. 3) and a portion Q6 of the secondary terminals 31s where the distance to the creeping distance extension face 22c is 1 mm (the portion where d1=1 mm in FIG. 3), along the opaque sealing portion 22. In this measurement of the creeping distance CD, a portion where the distance between the primary terminals 31f (or secondary terminals 31s) and the creeping distance extension face 22c is less than 1 mm is considered to be filled with an insulating material.

More specifically, with an optical coupling element 101 in which the distance between the terminals 31 and the side faces 22hs is less than 1 mm, the creeping distance CD is expressed by the following Formula (2) (referring to FIG. 3).

Creeping distance CD=Q1Q2+Q2Q3+Q3Q4+Q4Q5+Q5Q6 (2)

With a conventional optical coupling element in which the external shape of the opaque sealing portion 22 is substantially the same, but no creeping distance extension faces 22c are provided, the creeping distance CD is expressed by the following Formula (3).

Creeping distance CD=Qa1Q3+Q3Q4+Q4Qa6 (3)

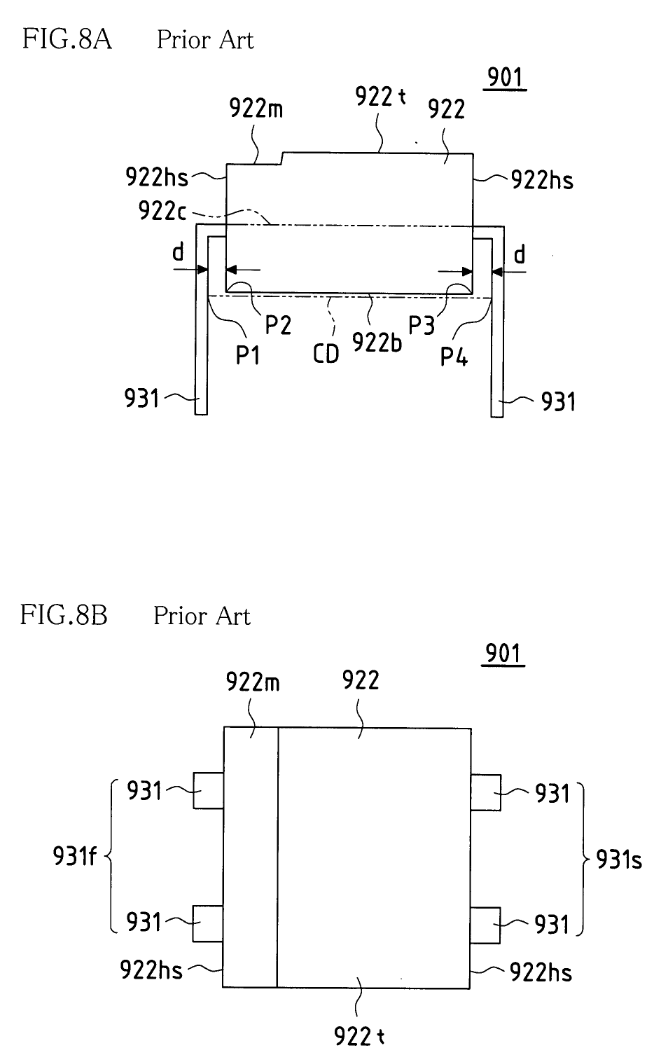

Here, Qa1 is a portion corresponding to P1 in FIG. 8, and Qa6 is a portion corresponding to P4 in FIG. 8.

In other words, providing the creeping distance extension faces 22c allows the creeping distance CD to be lengthened by the difference between the creeping distance of Formula (2) and the creeping distance of Formula (3) (Q1Q2+Q2Q3−Qa1Q3+Q4Q5+Q5Q6−Q4Qa6).

Specifically, with an optical coupling element 101 in which the distance between the terminals 31f, 31s and the side face 22hs is less than 1 mm, safety regulations require that the creeping distance CD be equal to the spatial distance, but the creeping distance CD as measured by a special measurement method can be lengthened by providing the creeping distance extension faces 22c that separate the terminals 31f and 31s from the side faces 22hs by more than 1 mm. Therefore, insulation between the terminals can be increased.

Furthermore, the optical coupling element 101 according to the present invention is not limited to being constituted by the pair of the light emitting element 11 and the light receiving element 12 as described in this embodiment, and may instead by constituted by providing creeping distance extension faces 22c to a plurality of pairs of the light emitting element 11 and light receiving element 12.

### Embodiment 2

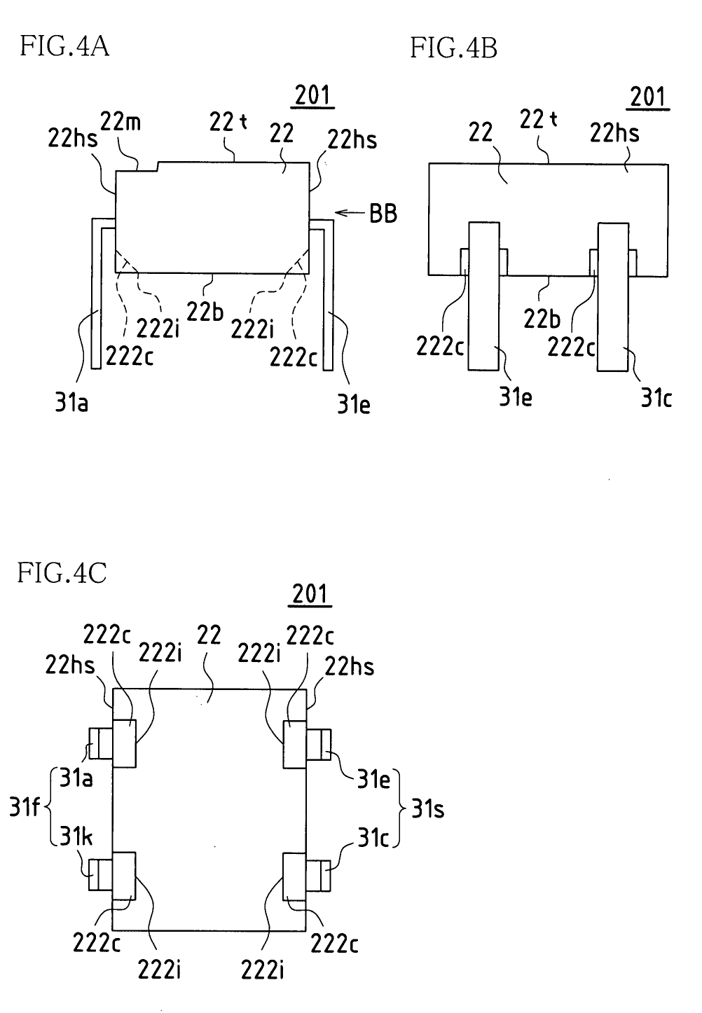

FIG. 4A is a side view of the optical coupling element according to Embodiment 2 of the present invention, FIG. 4B is a side view in the direction of arrow BB in FIG. 4A, and FIG. 4C is a bottom view of the optical coupling element according to Embodiment 2 of the present invention. The constitution of an optical coupling element 201 is the same as that in Embodiment 1 except for the creeping distance extension faces, and will therefore not be described again, and only the constitution of creeping distance extension faces 222c will be described here.

The creeping distance extension faces 222c are formed as cut-off faces with an angle of about 45 degrees, each formed from a side face 22hs to the bottom face 22b. Also, the creeping distance extension faces 222c are provided individually at the drawn-out location of each of the terminals 31a, 31k, 31c and 31e. The cut-off angle is not limited to being 45 degrees, and may be any angle that allows the corners formed by the side faces 22hs and the bottom face 22b in a conventional optical coupling element to be cut off. Also, the edges 222i formed by the bottom face 22b and the creeping distance extension faces 222c are formed so as to be more than 1 mm away from the terminals 31.

The effect of providing these creeping distance extension faces 222c is that the primary terminals 31f (or secondary terminals 31s) are separated from the side edges of the bottom face 22b, and the creeping distance CD is lengthened between the primary terminals 31f and the secondary terminals 31s, so insulation between the terminals is increased. Also, the effect of providing the creeping distance extension faces 222c individually at the drawn-out location of each of the terminals 31 is that the creeping distance CD can be lengthened without reducing the amount of resin in the opaque sealing portion 22. Also, since a reduction in the surface area of the bottom face 22b can be made small, mounting on the mounting substrate is more stable.

### Embodiment 3

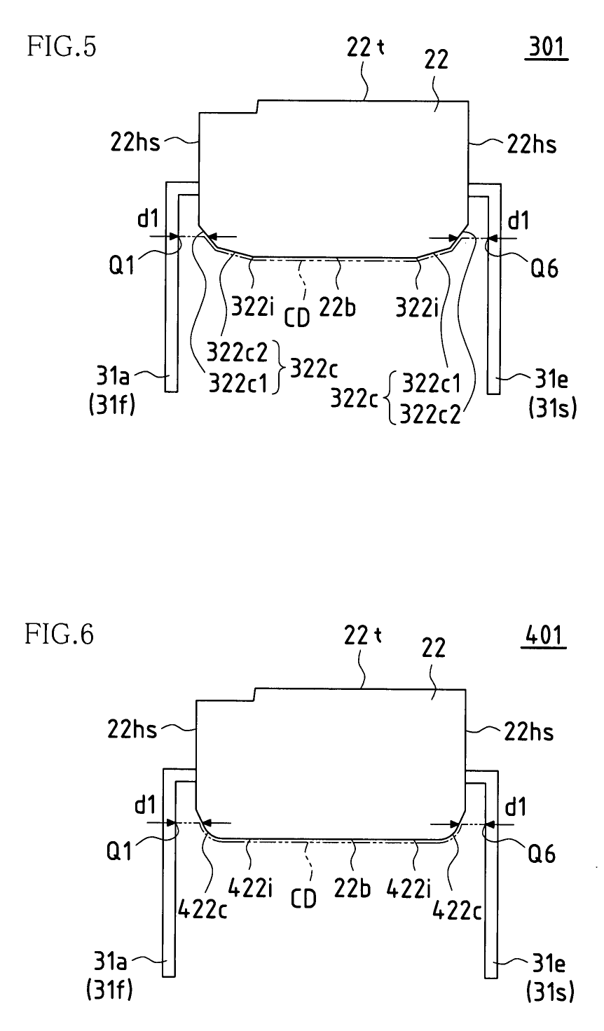

FIG. 5 is a side view of the optical coupling element according to Embodiment 3 of the present invention. The constitution of an optical coupling element 301 is the same as that in Embodiment 1, and will not be described again. Here, the constitution of a creeping distance extension faces 322c will be described.

The creeping distance extension faces 322c are formed as cut-off faces, each formed from a side face 22hs of the opaque sealing portion 22 to the bottom face 22b of the same, and are each constituted by two planar surfaces 322c1 and 322c2 that link the above faces (the side face 22hs and the bottom face 22b). The creeping distance extension faces 322c may be provided from the front end 22fe to the rear end 22re of the opaque sealing portion 22, or may be provided individually at the drawn-out location of each of the terminals 31a, 31k, 31c and 31e. The number of planar surfaces that constitute the creeping distance extension face 322c is not limited to two, and it may be constituted by three or more planar surfaces. Also, the edges 322i between the creeping distance extension faces 322c and the bottom face 22b are formed so as to be more than 1 mm away from the terminals 31.

The creeping distance CD of this optical coupling element 301 is calculated by measuring the distance between a portion Q1 of the primary terminals 31f where the distance to the creeping distance extension face 322c is 1 mm (the portion where d1=1 mm in FIG. 5) and a portion Q6 of the secondary terminals 31s where the distance to the creeping distance extension face 322c is 1 mm (the portion where d1=1 mm in FIG. 5), along the opaque sealing portion 22.

The effect of providing these creeping distance extension faces 322c is that the primary terminals 31f (or secondary terminals 31s) are separated from the side edge of the bottom face 22b, and the creeping distance CD is lengthened between the primary terminals 31f and the secondary terminals 31s, so insulation between the terminals is increased.

Also, because the creeping distance extension faces are each made up of two planar surfaces, there is greater latitude in designing the opaque sealing portion 22. For instance, the opaque sealing portion 22 can be given the appropriate thickness by forming the creeping distance extension faces 322c by disposing a plurality of planar surfaces so that they bulge outward.

### Embodiment 4

FIG. 6 is a side view of the optical coupling element according to Embodiment 4 of the present invention. The constitution of an optical coupling element 401 is the same as that in Embodiment 1, and will not be described again. Here, the constitution of a creeping distance extension faces 422c will be described.

The creeping distance extension faces 422c are formed as cut-off faces, each formed from a side face 22hs to the bottom face 22b, and are each constituted as a curved surface that links the above faces (the side face 22hs and the bottom face 22b). Also, the creeping distance extension faces 422c may be provided from the front end 22fe to the rear end 22re of the opaque sealing portion 22, or may be provided individually at the drawn-out location of each of the terminals (see FIG. 1 for the reference numbers of the opaque sealing portion 22). Also, the edges 422i between the creeping distance extension faces 422c and the bottom face 22b are formed so as to be more than 1 mm away from the primary terminals 31f (or the secondary terminals 31s).

The creeping distance CD of this optical coupling element 401 is calculated by measuring the distance between a portion Q1 of the primary terminals 31f where the distance to the creeping distance extension face 422c is 1 mm (the portion where d1=1 mm in FIG. 6) and a portion Q6 of the secondary terminals 31s where the distance to the creeping distance extension face 422c is 1 mm (the portion where d1=1 mm in FIG. 6), along the opaque sealing portion 22.

The effect of providing these creeping distance extension faces 422c is that the primary terminals 31f (or secondary terminals 31s) are separated from the side edges of the bottom face 22b, and the creeping distance CD is lengthened between the primary terminals 31f and the secondary terminals 31s, so insulation between the terminals is increased.

Also, because the creeping distance extension faces 422c are each made up of a curved surface, there is greater latitude in designing the opaque sealing portion 22. For instance, as shown in FIG. 6, the opaque sealing portion 22 can be given the appropriate thickness by forming the creeping distance extension faces 422c as curved surfaces that bulge outward.

### Embodiment 5

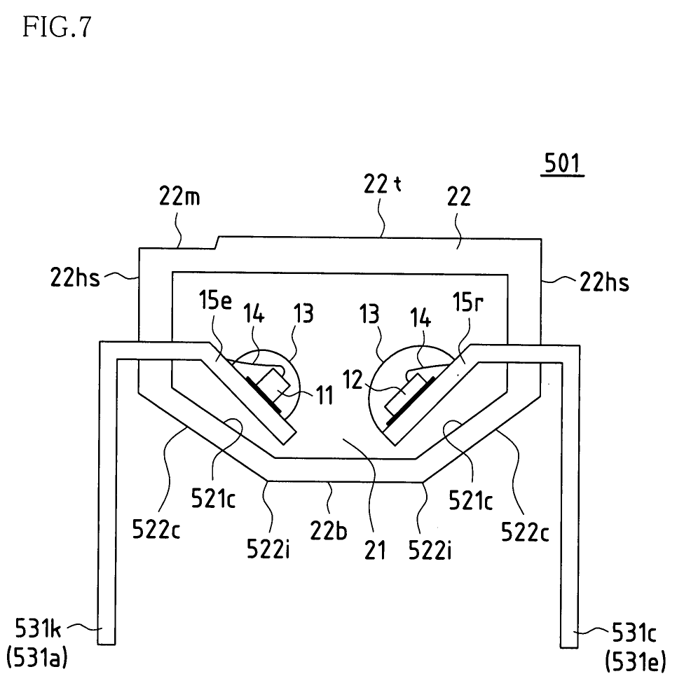

FIG. 7 is a cross section of the optical coupling element according to Embodiment 5 of the present invention. The constitution of an optical coupling element 501 is the same as that in Embodiment 1 except for the constitution of the transparent resin, the light emitting element mounting portion, and the light receiving element mounting portion, so constituent portions that are the same are numbered the same, and only the differences will be described.

The optical coupling element 501 according to this embodiment is made up of a transparent sealing portion 21 that seals a light emitting element 11 and a light receiving element 12 that have been coated with a transparent resin 13, an opaque sealing portion 22 that covers the transparent sealing portion 21, primary terminals 31f connected to the light emitting element 11, and secondary terminals 31s connected to the light receiving element 12.

The light emitting element 11 and the light receiving element 12 are mounted on the light emitting element mounting portion 15e of the primary terminals 31f and the light receiving element mounting portion 15r of the secondary terminals 31s, respectively.

The transparent sealing portion 21 integrally covers and seals the light emitting element 11 and the light receiving element 12. The transparent sealing portion 21 is provided with faces 521c that conform to creeping distance extension faces 522c at locations corresponding to the creeping distance extension faces 522c of the opaque sealing portion 22. More specifically, when the creeping distance extension faces 522c are formed as cut-off faces with an angle of about 45 degrees, the faces 521c that conform to the creeping distance extension faces 522c are formed by being cut-off at approximately 45 degrees at corresponding locations. As a result, the opaque sealing portion 22 can be given a substantially uniform thickness.

The opaque sealing portion 22 covers the transparent sealing portion 21, protects the entire optical coupling element from heat, and is formed from a resin that is resistant to heat. The creeping distance extension faces 522c are formed from the side faces 22hs to the bottom face 22b of the opaque sealing portion 22.

The creeping distance extension faces 522c are formed with respect to the faces 521c that conform to the creeping distance extension faces 522c formed on the transparent sealing portion 21. Also, the edges 522i between the creeping distance extension faces 522c and the bottom face 22b are formed so as to be more than 1 mm away from the primary terminals 31f (or secondary terminals 31s).

The primary terminals 31f and secondary terminals 31s are disposed across from each other with the opaque sealing portion 22 in between. The primary terminals 31f are made up of a cathode terminal 531k and an anode terminal 531a (hidden by the cathode terminal 531k in FIG. 7). The secondary terminals 31s, meanwhile, are made up of a collector terminal 531c and an emitter terminal 531e (hidden by the collector terminal 531c in FIG. 7).

The light emitting element 11 is mounted on the light emitting element mounting portion 15e formed at one end of the cathode terminal 531k. This light emitting element mounting portion 15e is bent substantially parallel to the faces 521c that conform to the creeping distance extension faces 522c formed on the transparent sealing portion 21. The other end of the cathode terminal 531k is drawn out to the outside from the side face 22hs of the opaque sealing portion 22.

A connection portion (not shown) formed at one end of the anode terminal 531a is connected by a gold (Au) wire 14 or the like to a surface electrode of the light emitting element 11. This connection portion is bent substantially parallel to the faces 521c that conform to the creeping distance extension faces 522c formed on the transparent sealing portion 21. The other end of the anode terminal 531a is drawn out to the outside from the side face 22hs of the opaque sealing portion 22. The bending of the light emitting element mounting portion 15e and the connection portion is not limited to being substantially parallel to the faces 521c that conform to the creeping distance extension faces 522c, and instead the light emitting element 11 may be bent so that it faces in the direction of the light receiving element 12.

The light receiving element 12 is mounted on the light receiving element mounting portion 15r formed at one end of the collector terminal 531c. This light receiving element mounting portion 15r is bent so as to be substantially parallel to the faces 521c that conform to the creeping distance extension faces 522c. The other end of the collector terminal 531c is drawn out to the outside from the side face 22hs of the opaque sealing portion 22.

A connection portion (not shown) formed at one end of the emitter terminal 531e is connected by a gold (Au) wire 14 or the like to an emitter electrode formed on the light receiving element 12. This connection portion is bent substantially parallel to the faces 521c that conform to the creeping distance extension faces 522c formed on the transparent sealing portion 21. The other end of the emitter terminal 531e is drawn out to the outside from the side face 22hs of the opaque sealing portion 22. The bending of the light receiving element mounting portion 15r and the connection portion is not limited to being substantially parallel to the faces 521c that conform to the creeping distance extension faces 522c, and instead the light receiving element 12 may be bent so that it faces in the direction of the light emitting element 11.

The effect of this constitution is that the optical axes of the light emitting element 11 and the light receiving element 12 intersect, so optical transmission efficiency can be increased. Furthermore, in this embodiment, the light emitting element mounting portion 15e of the cathode terminal 531k and the light receiving element mounting portion 15r of the collector terminal 531c are both bent, but one may instead be inclined toward the bottom face 22b of the opaque sealing portion 22.

Also, providing the creeping distance extension faces 522c separates the primary terminals 31f (or the secondary terminals 31s) from the side edge of the bottom face 22b and lengthens the creeping distance CD between the primary terminals 31f and the secondary terminals 31s, so insulation between the terminals is increased.

Also, because the faces 521c that conform to the creeping distance extension faces 522c are formed on the transparent sealing portion 21, it is possible to ensure enough thickness to maintain heat resistance at locations corresponding to the creeping distance extension faces 522c.

An insertion type optical coupling element is described in this embodiment, but a similar effect can be obtained with a surface mount type optical coupling element.

The electronic device according to the present invention is equipped with at least one load control circuit. The load control circuit controls a load circuit to perform the main functions of the electronic device. The load control circuit is made up of a control circuit for controlling the load circuit, and a connection portion for exchanging signals with the load circuit. The optical coupling elements 101, 201, 301, 401 and 501 according to the above embodiments can be used with this connection portion.

These optical coupling elements 101 to 501 allow the creeping distance CD to be lengthened without increasing the mounting surface area, so the electrical safety of an electronic device can be enhanced while still keeping the size of the device small.

The present invention can be worked in various other forms without departing from the main characteristics or essence thereof. Accordingly, the examples given above are in all respects nothing more than mere examples, and should not be construed as being limiting in nature. The scope of the present invention is indicated by the Claims, and is in no way restricted by the text in this Specification. Furthermore, alterations and modifications within a scope equivalent to that given in the Claims are all encompassed by the scope of the present invention.

1. An optical coupling element, comprising a light emitting element and a light receiving element, a transparent sealing portion for sealing these elements, an opaque sealing portion that covers the transparent sealing portion, and terminals that are connected individually to the electrodes of the light emitting element and the light receiving element and are drawn out from a side face of the opaque sealing portion, the creeping distance being the sum of the gap distance between these terminals and their opposite side faces and the distance between the bottom edges of the side faces,
wherein a creeping distance extension face for extending the creeping distance is provided between the bottom face and the side face of the opaque sealing portion, and the gap distance between the terminals and the edge formed by the bottom face and this creeping distance extension face is set to a specific distance.

2. The optical coupling element according to claim 1, wherein the specific distance is greater than 1 mm.

3. The optical coupling element according to claim 1, wherein the creeping distance extension face is planar.

4. The optical coupling element according to claim 1, wherein the creeping distance extension face comprises a plurality of faces.

5. The optical coupling element according to claim 1, wherein the creeping distance extension face is curved.

6. The optical coupling element according to claim 1, wherein the creeping distance extension face is provided individually at the drawn-out location of each of the terminals.

7. The optical coupling element according to claim 1, wherein the transparent sealing portion is formed such that portions corresponding to the creeping distance extension faces form faces that conform to the creeping distance extension face.

8. The optical coupling element according to claim 1, wherein light emitting element mounting portions and/or light receiving element mounting portions of the terminals are inclined toward the bottom face.

9. An electronic device comprising a load control circuit for controlling a load circuit, wherein the load control circuit comprises an optical coupling element according to claim 1.
